(19) United States
(12) Patent Application Publication
(10) Pub. No.: US 2006/0230237 A1
(43) Pub. Date: Oct. 12, 2006

(54) Method and system for maintaining cache coherence of distributed shared memory system

(75) Inventor: Mariko Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/214,850

(22) Filed: Aug. 31, 2005

(30) Foreign Application Priority Data
Apr. 7, 2005 (JP) 2005-111242

(51) Int. Cl. G06F 13/28

(52) U.S. Cl. 711/141

(57) ABSTRACT

A distributed shared memory system includes a plurality of nodes. Each of the nodes includes a plurality of shared multiprocessors. Each of the shared multiprocessors includes a processor, a shared cache, and a memory. Each of the nodes includes a coherence maintaining unit that maintains cache coherence based on a plurality of directories each of which corresponding to each of the shared caches included in the distributed shared memory system.

### BACKGROUND OF THE INVENTION

1. Field of the Invention

The present invention relates to a technology for increasing the speed of coherence control of a distributed shared memory system, and thereby enhancing the performance of the system. Coherence control means a process to control the sequence of a plurality of update/reference operations to the shared caches in the system so that a copy of a memory data stored in the shared caches does not affect the result of the update/reference operation.

2. Description of the Related Art

Cache coherence control in a small scale distributed shared memory system is carried out by means of a snoopy coherence protocol. Although the snoopy coherence protocol functions effectively in a small scale system, usage of the snoopy coherence protocol in a large scale system results in a bottleneck of busses. Cache coherence control in a large scale system is carried out by means of a directory-based protocol.

In a widely used method in the directory-based protocol, a main memory-based directory is created. FIG. 14 is a drawing of the main memory-based directory. As shown in FIG. 14, when using the main memory based directory, status of a memory data is controlled in units of size of a cache block. Thus, a total number of entries in a memory directory 320 becomes equal to a number obtained by dividing the total amount of a main memory 310 by the size of the cache block, and the number is large.

Due to this, methods such as configuration of a directory in sub sets of the entire data, or creation of a hierarchical directory are developed and used. However, unnecessary controls can occur resulting in a longer time for directory access in the aforementioned methods.

A sparse directory method is disclosed in A. Gupta and W. D. Weber “Reducing Memory and Traffic Requirements for Scalable Directory-Based Cache Coherence Schemes” (In Proceedings of the 1990 ICPP, pages 312 to 322, August 1990) in which a cache based directory is created instead of a main memory-based directory commonly used in memory-based methods.

FIG. 15 is a drawing of a sparse directory. As shown in FIG. 15, in a sparse directory 330, because the size of the cache is small as compared to the total amount of the main memory 310, directory size can be reduced. However, in a system consisting of more than two nodes and having a processor and a cache in each node, when controlling coherence by means of a directory having a less number of entries than the total number of entries in all the caches of the system (for example, when the number of entries in the directory is equal to the number of entries in a single cache), conflict occurs between the entries in the directory, and all the necessary data cannot be maintained.

A complete and concise remote (CCR) directory is disclosed in U.S. Pat. No. 6,338,123 in which the concept of the sparse directory is further improvised. In the CCR directory, number of directories in each node is one less than the total number of nodes. When the CCR directory is used in a system having a single shared cache in each node, each directory establishes a one to one correspondence with the shared caches in nodes other than the node that includes the directory itself.

FIG. 16 is a drawing of the CCR directory. FIG. 17 is a drawing of the distributed shared memory system provided with the CCR directory. In the CCR directory of the distributed shared memory system consisting of eight nodes (nodes A through H), a directory of the node A is shown in FIG. 16. The node A includes seven directories that correspond to the shared caches included in the nodes B through H. The drawback of occurrence of conflict between entries of a single directory in the sparse directory method can be overcome in the CCR directory.

However, in the CCR directory, if there are multiple shared caches in a node, because the shared caches are controlled by means of a single directory, conflict occurs between entries of the directory and all the necessary data cannot be maintained. Thus, valid entries of the directory need to be removed, thereby lowering the performance of coherence control.

### SUMMARY OF THE INVENTION

It is an object of the present invention to at least solve the problems in the conventional technology.

A distributed shared memory system according to an aspect of the present invention includes a plurality of nodes. Each of the nodes includes a plurality of shared multiprocessors. Each of the shared multiprocessors includes a processor, a shared cache, and a memory. Each of the nodes including a coherence maintaining unit that maintains cache coherence based on a plurality of directories each of which corresponding to each of the shared caches included in the distributed shared memory system.

A multiprocessor device according to another aspect of the present invention includes a plurality of processors, a plurality of shared caches, and a memory, and forms a distributed shared memory system with another multiprocessor device connected to the multiprocessor device via a network. The multiprocessor device includes: a shared-cache connecting unit that connects the shared caches; and a coherence maintaining unit that is connected to the shared caches via the shared-cache connecting unit.

A method according to still another aspect of the present invention is a method of maintaining cache coherence of a distributed shared memory system including a plurality of nodes. Each of the nodes includes a plurality of shared multiprocessors. Each of the shared multiprocessors includes a processor, a shared cache, and a memory. The method includes: receiving a request for one of the shared caches included in the distributed shared memory system from one of the shared multiprocessors; and maintaining, when the request received is a store request, the cache coherence based on a plurality of directories each of which corresponding to each of the shared caches included in the distributed shared memory system.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a distributed shared memory according to an embodiment of the present invention;

FIG. 2 is a block diagram of a coherence controller according to the embodiment;

FIG. 3 is a drawing of a structure of a directory;

FIG. 4 is a drawing illustrating enhancement of the speed of coherence control by means of providing an “Updating” status as a cache status included in the directory;

FIG. 5 is a drawing illustrating a parallel directory access by interleaving entries of the directory by means of a memory address;

FIG. 6 is a block diagram of a shared cache included in a shared multiprocessor (SMP);

FIG. 7 is a flowchart of a process performed by the coherence controller in response to a request from the SMP;

FIG. 8 is a flowchart of a memory data request generating process;

FIG. 9 is a block diagram of a coherence controller provided with an updating status release wait buffer;

FIG. 10 is a flowchart of a process performed by the coherence controller of a home node;

FIGS. 11A and 11B are drawings of a format of a request packet;

FIG. 12 is a drawing of an example of a basic information packet;

FIG. 13 is a drawing of an example of a directory specifying information packet;

FIG. 14 is a drawing of a main memory-based directory;

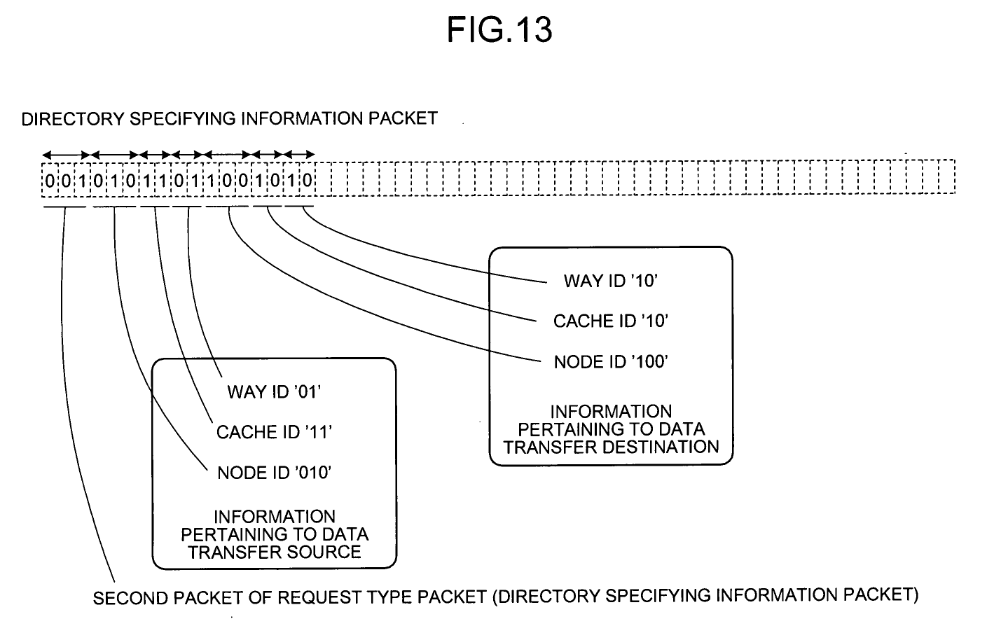

FIG. 15 is a drawing of a sparse directory;

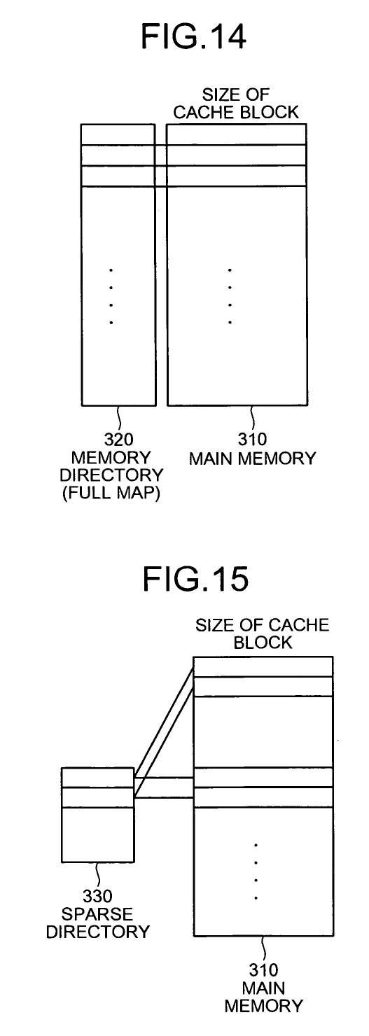

FIG. 16 is a drawing of a complete and concise remote (CCR) directory; and

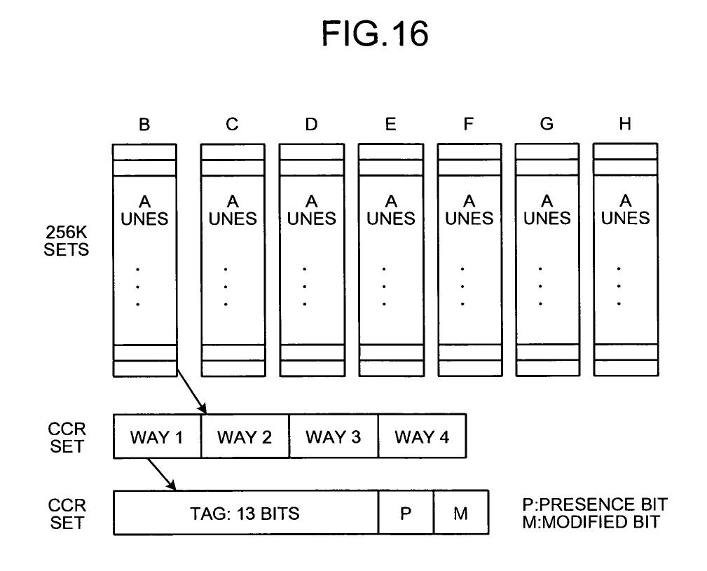

FIG. 17 is a drawing of a distributed shared memory system provided with the CCR directory.

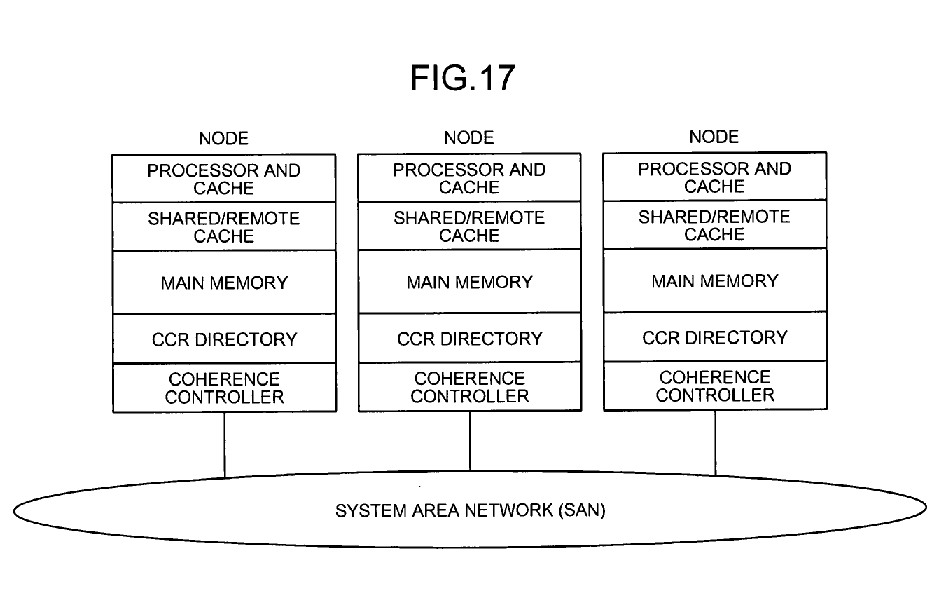

### DETAILED DESCRIPTION OF THE PREFERRED EMBODIMENTS

Exemplary embodiments of the present invention are explained below in detail with reference to the accompanying drawings.

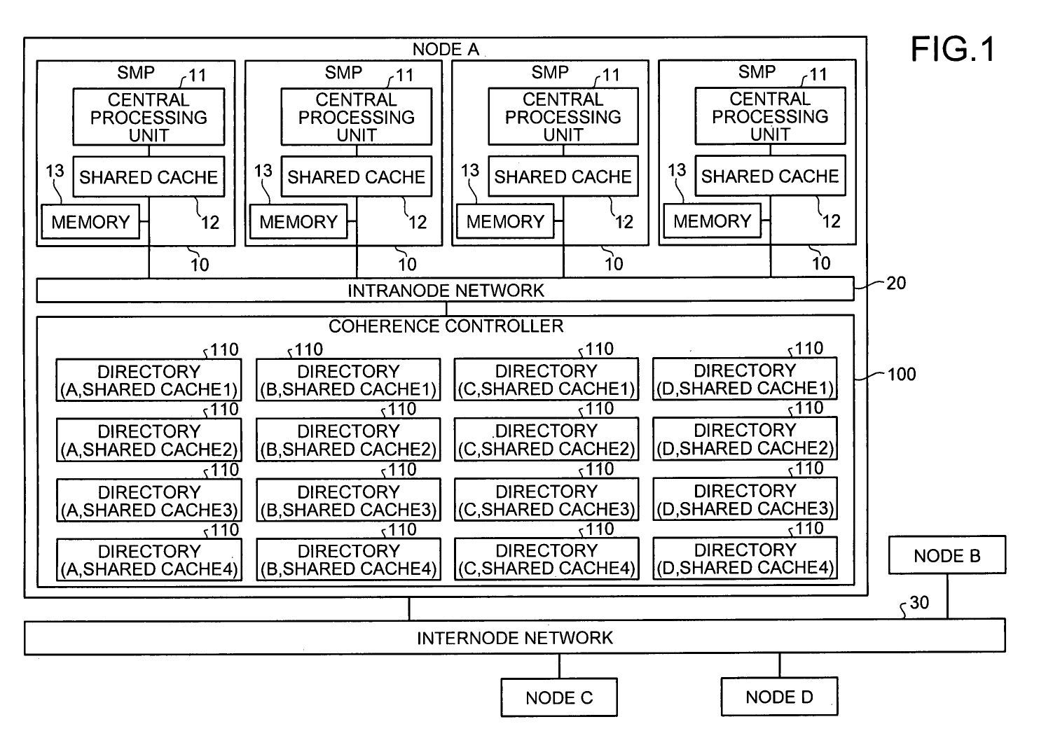

FIG. 1 is a block diagram of a distributed shared memory according to an embodiment of the present invention.

As shown in FIG. 1, the distributed shared memory system includes a node A, a node B, a node C, and a node D connected to an internode network 30. Each node includes four shared multiprocessors (SMP) 10, an intranode network 20 that connects the SMP 10, and a coherence controller 100 which is connected to the SMP 10 via the intranode network 20 and controls cache coherence in node units. The SMP 10 and the coherence controller 100 can also be connected by means of a bus instead of the intranode network 20.

Each of the SMP 10 includes a Central Processing Unit (CPU) 11 having multiple processors, a shared cache 12, and an interleaved memory 13. The shared cache 12 is the bottommost layer of a hierarchical cache, in other words, a cache nearest the memory 13, and becomes the object of cache coherence.

Although for the sake of convenience, the distributed shared memory system including four nodes having four SMP 10 in each node is explained in the present embodiment, a distributed shared memory system including a larger number of nodes having a larger number of SMP 10 in each node can also be structured.

The coherence controller 100 includes directories 110 that establish a one to one correspondence with the shared caches 12 in each of the nodes A, B, C, and D. In other words, the coherence controller 100 includes sixteen directories 110 (4(number of nodes)×4(number of shared caches)).

Each of the directories 110 contain information pertaining to memory data which is a copy of the memory 13 included in the same node, and memory data which is a copy of the memory 13 included in the other nodes. Each directory 110 that corresponds to the shared caches 12 of the other nodes contains only information pertaining to copy of memory data of the memory 13 included in the same node. In other words, the directory 110 becomes a subset of a tag table of the corresponding shared caches 12.

Thus, in the distributed shared memory system according to the present embodiment, the coherence controller 100 in each of the nodes includes the directories 110 that establish a one to one correspondence with all the shared caches 12 of all the nodes, thereby enabling to prevent the occurrence of conflict in entries of the directories 110 and increase the speed of coherence control.

Because of advancement in the miniaturization techniques due to the latest technology, all the directories in the node can be loaded on a high speed Random Access Memory (RAM), thereby enabling to realize the aforementioned structure of the directories. Realizing the aforementioned structure of the directories will become easier with the passage of time.

In the distributed shared memory system according to the present embodiment, because the SMP 10 are connected with the intranode network 20, the SMP 10 can communicate with the other SMP 10 included in the same node without communicating via the coherence controller 100. Thus, the speed of communication between the SMP 10 in the node can be increased.

In the present embodiment, a memory data is specified by means of a memory address. A node, which contains the specified memory data in the memory 13 included in the same node, is called a home node. A request source node that issues a request between the nodes due to hits and mishits of the shared caches 12 is called a local node. A node (group of nodes) other than the home node and the local node, which contains a copy of a requested memory data in the shared caches 12, is called a remote node.

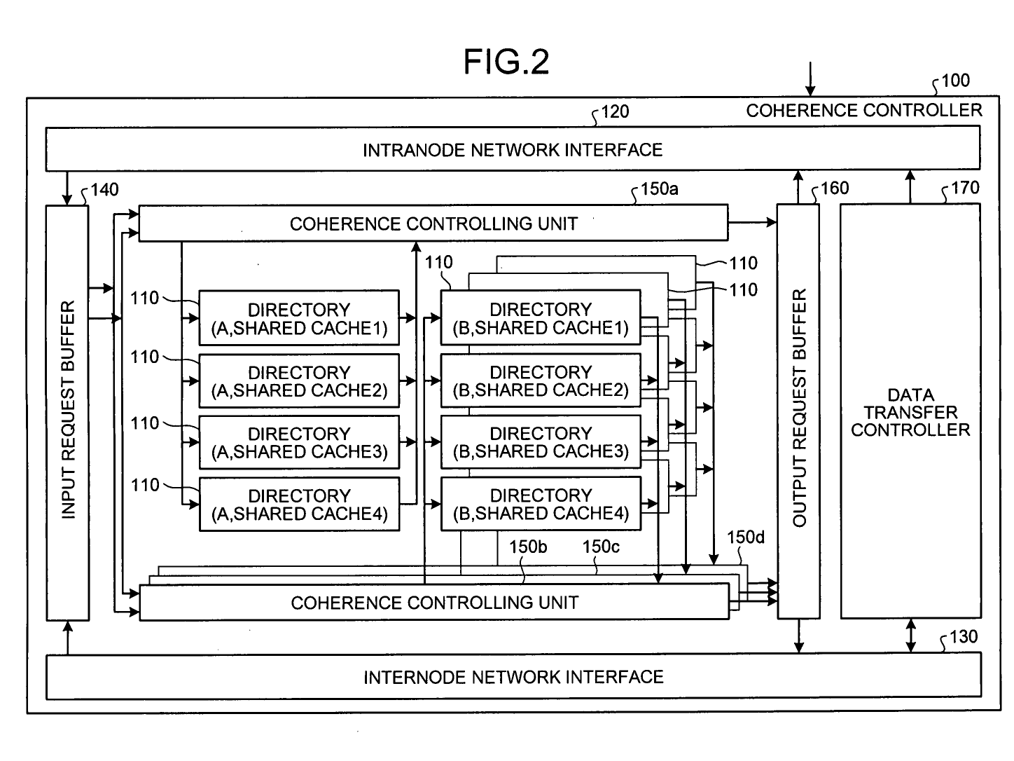

FIG. 2 is a block diagram of the coherence controller 100 according to the present embodiment. As shown in FIG. 2, the coherence controller 100 includes sixteen directories 110, an intranode network interface 120, an internode network interface 130, an input request buffer 140, coherence controlling units 150a through 150d, an output request buffer 160, and a data transfer controller 170.

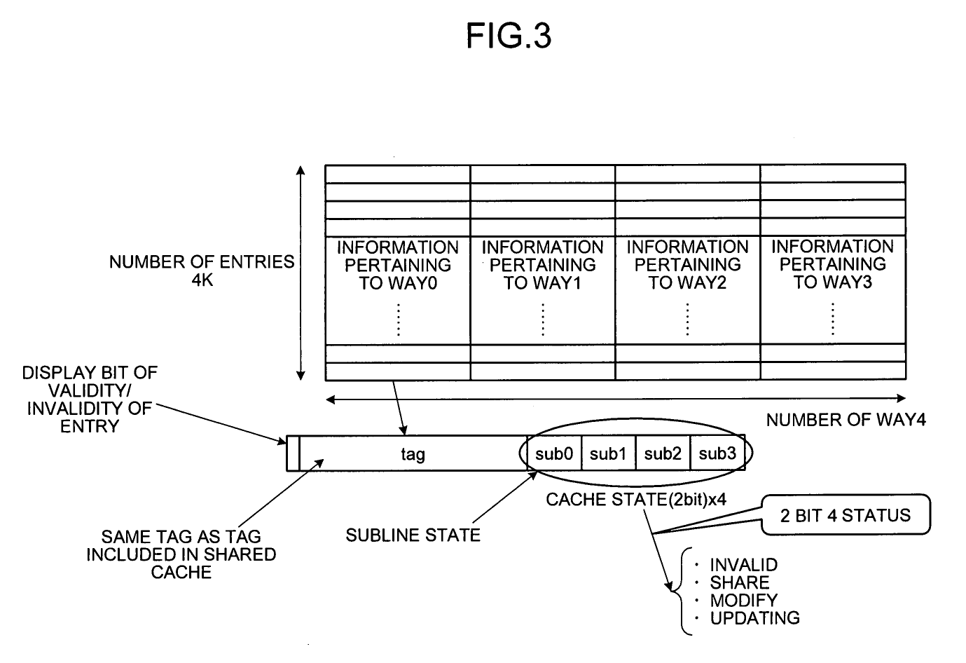

The directories 110 establish a one to one correspondence with each of the shared caches 12 in each node and store cache information. FIG. 3 is a drawing of a structure of the directory 110. The directory 110 shown in FIG. 3 establishes a correspondence with the shared cache 12 having a size of 4 megabytes, a line size of 256 bytes, and 4-way set associative having a sub line size of 64 bytes. The directory 110 contains 4K entries.

Each entry in the directory 110 includes a bit that indicates whether the entry is valid or invalid, a tag which matches with a tag stored in a cache tag table and which is used to specify data included in a cache, and sub 0 through sub 3 that indicate a cache status for every sub line.

Information that indicates a status of a cache included in the entry includes “Invalid” which indicates that content of the cache is invalid, “Share” which indicates that a copy of data in the cache can be simultaneously shared by another cache, “Modify” which indicates that the cache content is modified and a copy of the same data cannot be shared simultaneously by another cache, and “Updating” which indicates that a data block in the memory address controlled by the entry is being updated.

Conventionally the information pertaining to “Updating” status is controlled by means of a table other than the directory 110 to lock a simultaneous access to an entry having multiple independent processes. In the present embodiment, the “Updating” status is included in the cache status of the directory 110, thereby enabling to exercise lock control etc. exclusively by means of the directory 110.

Moreover, in the present embodiment, the “Updating” status is provided as the cache status within the directory 110. Thus, instead of assigning status accountability exclusively to the home node or to the local node, accountability for status updating can be switched between the home node and the local node according to specific conditions, thereby enhancing the speed of coherence control.

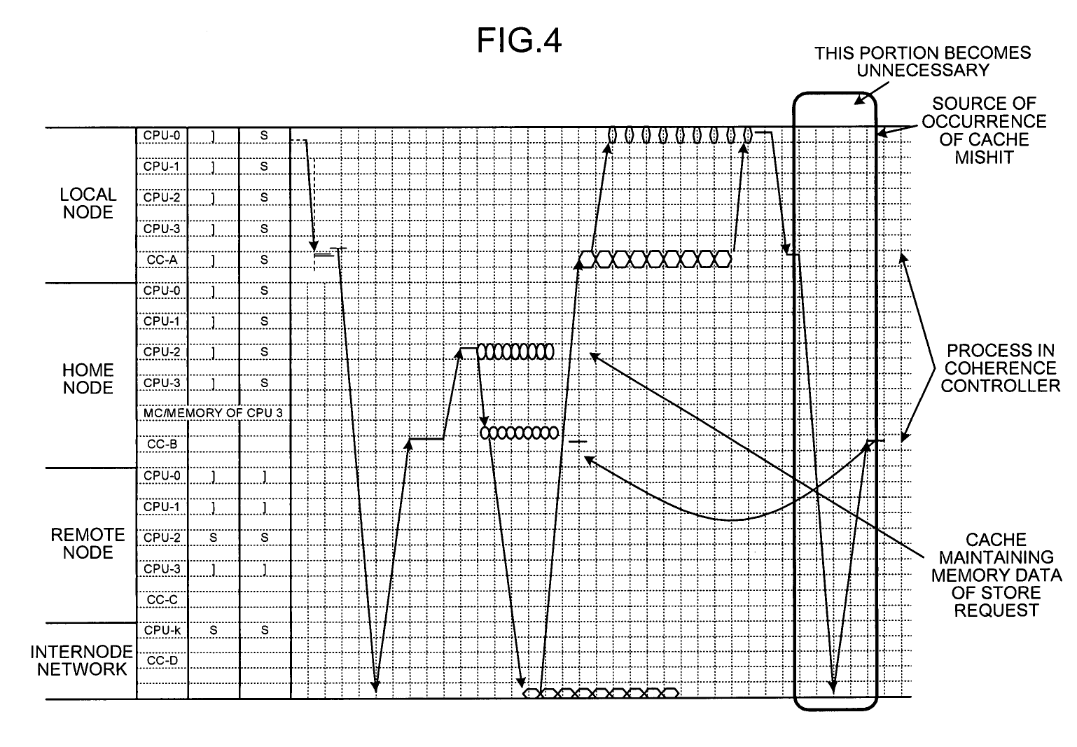

FIG. 4 is a drawing illustrating enhancement of the speed of coherence control by means of providing the “Updating” status as the cache status within the directory 110. As shown in FIG. 4, in a sequence according to conventional method, when the local node, due to a cache mishit, makes a request to store data in the cache to the home node, the home node assumes accountability for status updating.

As shown in FIG. 4, when a cache mishit occurs in the local node, a coherence controller (CC-A) of the local node issues a memory data request to a coherence controller (CC-B) of the home node via an internode network. Next, the coherence controller (CC-B) sets the status of the requested memory data to “Updating” to lock other operations to the entry in the directory corresponding to the requested memory data and determines a transfer source of the requested memory data by referring to information pertaining to all the directories included in the same coherence controller (CC-B). In the example shown in FIG. 4, the coherence controller (CC-B) determines to transfer the requested memory data from a cache of the home node, reads the requested memory data from a cache specified as the transfer source, and sends the requested memory data to the coherence controller (CC-A) of the local node via the internode network. In the conventional method, when the memory data is transferred, the coherence controller (CC-B) maintains the “Updating” status of the requested memory data till copying of the requested memory data in the cache is completed. Moreover, in the conventional method, the cache status of the memory data for lock control is controlled separately from the cache status within the directory.

The coherence controller (CC-A) of the local node completes receiving the memory data from the coherence controller (CC-B), writes the memory data to the cache of the request source and notifies the coherence controller (CC-B) of the home node of completion of receipt of the memory data via the internode network. The coherence controller (CC-B) of the home node, upon receiving a receipt completion notification, modifies the “Updating” status of the memory data to “Not updating”.

The coherence controller 100 according to the present embodiment exercises control when the cache status of an entry within the directory 110 is “Updating”, and controls the cache status of the entry with the aid of the local node during a data transfer process between the nodes. Even if the coherence controller (CC-B), upon receiving a memory data request, sets the cache status of the data block of a cache mishit source to “Updating”, the cache status within the directory 110 can be modified from “Updating” to “Not updating” when data transfer to the coherence controller (CC-A) is completed. This is because in the directory 110 of the local node, the cache status of the corresponding data block is set to “Updating”. Thus, accountability for status updating can be assigned to the local node.

To be specific, when the local node issues a store data request, the coherence controller (CC-B) of the home node, by means of a string of process related to the store data request, either updates the memory 13 or removes a cache line in the cache of the local node. If the directory 110 corresponding to a remote node includes a cache that undergoes a status modification, the coherence controller (CC-B) maintains the cache status of the cache corresponding to write back/status updating of the directory 110 to “Updating” till write back is completed, or till a cache line is removed, or till a necessary request is issued to the remote node and a process confirmation notification is received. When write back is completed, removal of a cache line is completed, or a process confirmation notification is received from the remote node, the coherence controller (CC-B) modifies the cache status of the cache to “Shared”.

If the memory 13 is not modified, a cache line is not removed, or the corresponding directory 110 of the remote node does not include a memory that undergoes status modification, the coherence controller (CC-B) reads the memory data from the cache of the transfer source, and upon completion of data transfer to the coherence controller (CC-A) of the local node, modifies the cache status, from “Updating” to “Shared”, of the corresponding cache in the directory 110 of a node (home node in the example) that includes the cache from where the memory data is read.

Thus, the coherence controller (CC-A) of the local node does not need to notify the coherence controller (CC-B) of the home node of completion of receipt of the memory data via the internode network 30.

Thus, by providing “Updating” status as a cache status within the directory 110, the coherence controller 100 according to the present embodiment can reduce inter node communication, enable early confirmation of cache status, and enhance the performance of the entire distributed shared memory system.

Referring back to FIG. 2, the intranode network interface 120 interfaces with the intranode network 20, and the internode interface 130 interfaces with the internode network 30.

The input request buffer 140 stores a request from the SMP 10 via the intranode network interface 120 and a request from other nodes via the internode network interface 130.

The coherence controlling units 150a through 150d are pipelines that carry out processes related to coherence control by means of the directories 110. In other words, the coherence controlling units 150a through 150d carry out processes by taking requests from the input request buffer 140, generate requests to the SMP 10 or to other nodes, and output the generated requests to the output request buffer 160. Further, the coherence controlling units 150a through 150d carry out operations for the directories 110 if necessary.

The number of pipelines, the number of stages, the number of directories 110 that are accessed by a single pipeline, the mechanism of directory search can be selected as per convenience. For example, in the present embodiment, each of the coherence controlling units 150a through 150d carry out operations for the shared caches 112 of the nodes A through D respectively.

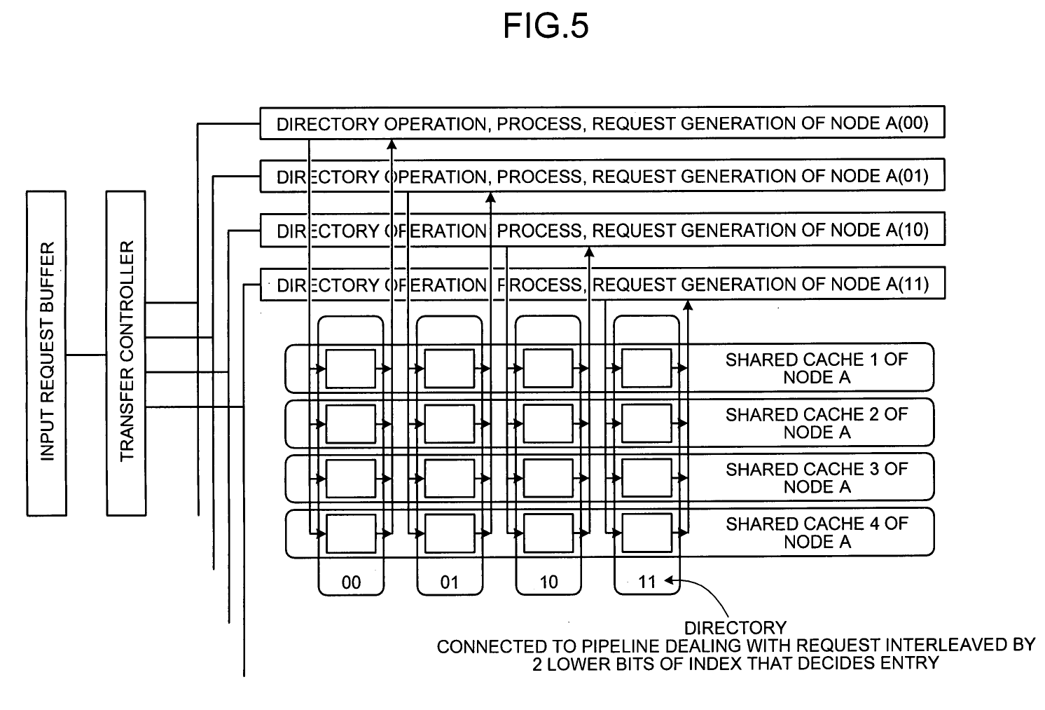

As shown in FIG. 5, interleaving entries of the directories 110 by means of a memory address, and providing a parallel directory access can increase the speed of directory search. Only a related pipeline is used to carry out a required process in response to a request packet that includes directory specifying information. The request packet that includes the directory specifying information is explained in detail later.

The output request buffer 160 stores a request that is transmitted to the SMP 10 via the intranode network interface 120, and a request that is transmitted to other nodes via the internode network interface 130.

The data transfer controller 170 controls transfer of cache data between other nodes and includes a buffer to store the memory data that is being transferred.

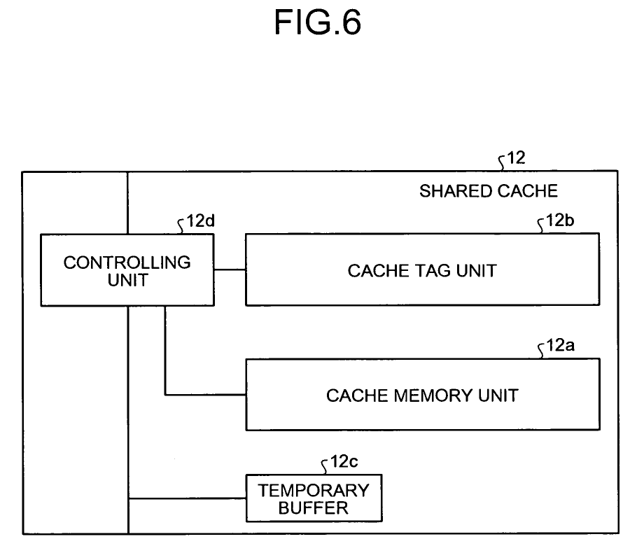

FIG. 6 is a block diagram of the shared cache 12 included in the SMP 10. As shown in FIG. 6, the shared cache 12 includes a cache memory unit 12a, a cache tag unit 12b, a temporary buffer 12c, and a controlling unit 12d.

The cache memory unit 12a stores a copy of memory data. The cache tag unit 12b stores a tag corresponding to the memory data stored in the cache memory unit 12a and a status of the copy of the memory data. The temporary buffer 12c temporarily stores the memory data read from the cache memory unit 12a.

The controlling unit 12d controls the shared cache 12 and carries out a fast transfer of data to other shared caches 12 within the node by means of the temporary buffer 12c and the intranode network 20.

To be specific, when a mishit occurs in the shared cache 12, the controlling unit 12d of the cache causing the mishit broadcasts to confirm whether the memory data exists in other shared caches 12 in the same node, and issues a store data request to the coherence controller 100. Each of the controlling units 12d of the other shared caches 12 confirms whether the requested memory data exists, and the memory data, if existing, is read by the cache memory unit 12a and temporarily stored in the temporary buffer 12c. On the other hand, upon receiving the store data request, the coherence controller 100 issues a store data request to the coherence controller 100 of the home node and simultaneously confirms whether a copy of the requested memory data exists in the shared caches 12 within the same node. If multiple copies of the requested memory data exist, the coherence controller 100 selects one of the copies and if only a single copy of the requested memory data exists, the coherence controller 100 instructs the shared cache 12 to transfer the memory data from the temporary buffer 12c to the shared cache 12 that has caused the mishit. The coherence controller 100 instructs the other shared caches 12 having copies of the requested memory data to cancel reading of the memory data or to discard the read memory data.

The controlling unit 12d of the shared cache 12 that receives a instruction from the coherence controller 100 to transfer the memory data causes the memory data to be read by the temporary buffer 12c and transfers the memory data via the intranode network 20 to other shared cache 12. The other shared caches 12 receive an instruction from the coherence controller 100 to release the temporarily stored memory data and release the memory data temporarily stored in the temporary buffer 12c.

The coherence controller 100 issues a store data request to the coherence controller 100 of the home node and simultaneously instructs the shared caches 12 in the same node to confirm whether the requested memory data exists. If the requested memory data exists, the shared cache 12 that receives the instruction to confirm the existence of the memory data prior reads the memory data, stores the memory data in the temporary buffer 12c, and upon receiving a transfer instruction from the coherence controller 100 transfers the memory data to other shared cache 12 within the node by means of the intranode network 20. Thus, if a cache mishit occurs in the shared cache 12, and the requested memory data exists in other shared cache 12 in the same node, a fast data transfer to the shared cache 12 of the store data request source can be carried out.

Broadcasting of whether the requested memory data exists in the shared caches 12 in the same node is explained. However, the coherence controller 100 can also select a specific shared cache 12 by searching the directories 110 within the node and instruct only the selected shared cache 12 to prior read the memory data.

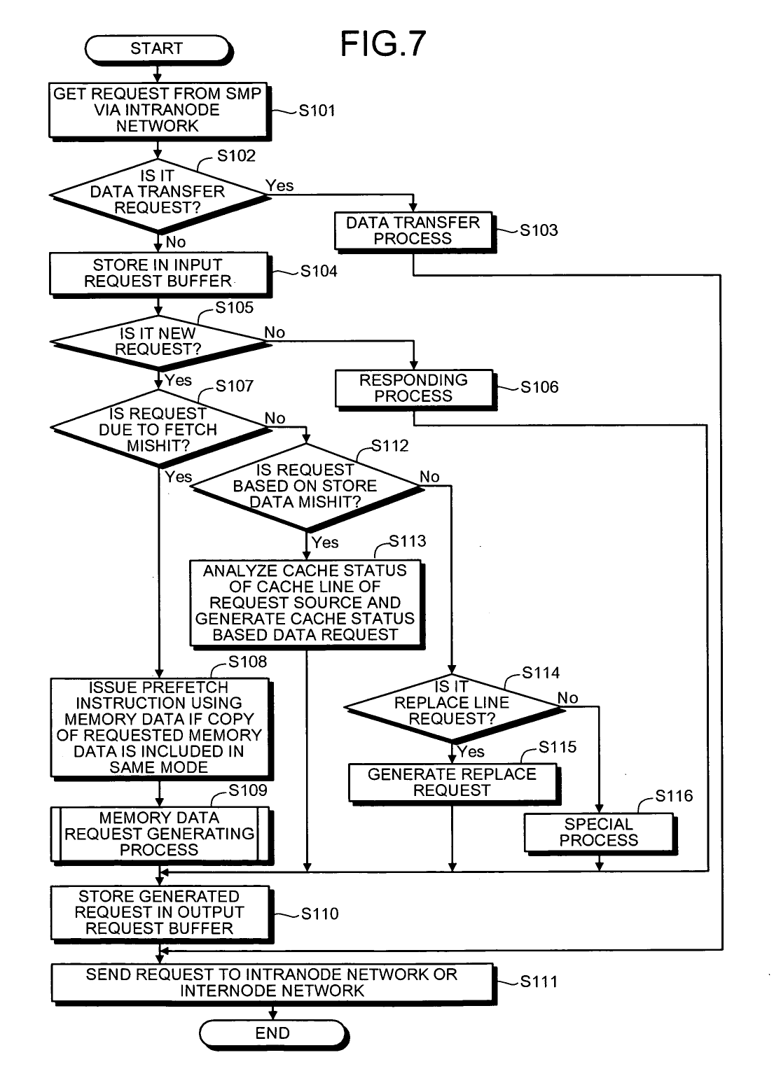

A sequence of a process of the coherence controller 100 is explained next with reference to FIG. 7 through FIG. 10. The process of the coherence controller 100 explained next is when the coherence controller 100 receives a request to store data in the shared cache 12 from the SMP 10 upon occurrence of a cache mishit in the shared cache 12.

FIG. 7 is a flowchart of the process performed by the coherence controller 100 in response to the request from the SMP 10. As shown in FIG. 7, the coherence controller 100, upon receiving a request from the SMP 10 via the intranode network 20 (step S101), determines whether the request is a transfer data request (step S102).

If the received request is a transfer data request, the coherence controller 100 carries out a data transfer process (step S103), and transmits data to the internode network 30 (step S111).

If the received request is not a transfer data request, the coherence controller 100 stores the request in the input request buffer 140 (step S104). Next, the coherence controller 100 takes the request from the input request buffer 140 and determines whether the request is a new request (step S105). If the request is not a new request, the coherence controller 100 carries out a responding process (step S106) and proceeds to step S110.

If the request taken from the input request buffer 140 is a new request, the coherence controller 100 determines whether the request is a store data request due to fetch mishit (step S107). If the request is a store data request due to fetch mishit, the coherence controller 100 searches the directories 110 within the same node for carrying out a prefetch process, and if a copy of the requested memory data is found in the same node, issues an instruction to carry out the prefetch process using the copy of the memory data (step S108). Next, the coherence controller 100 carries out a memory data request generating process to generate a memory data request (step S109), and stores the generated memory data request in the output request buffer 160 (step S110).

Next, the coherence controller 100 takes the memory data request from the output request buffer 160 and sends the memory data request to the internode network 30. If a copy of the requested memory data is included in the shared caches 12, the coherence controller 100 takes the memory data request from the output request buffer 160, and transmits the memory data request to the intranode network 20 (step S111).

If the request taken from the input request buffer 140 is not a store data request due to fetch mishit, the coherence controller 100 determines whether the request is a request based on a store data mishit (step S112). If the request is a request based on a store data mishit, the coherence controller 100 carries out a cache status analysis of the cache line of the request source, generates data request according to cache status (step S113), and proceeds to step S110.

If the request taken from the input request buffer 140 is not a request based on a store data mishit, the coherence controller 100 determines whether the request is a replace cache line request (step S114). If the request is a replace cache line request, the coherence controller 100 generates a replace request (step S115), and if the request is not a replace cache line request, carries out a special process (step S116) and proceeds to step S110.

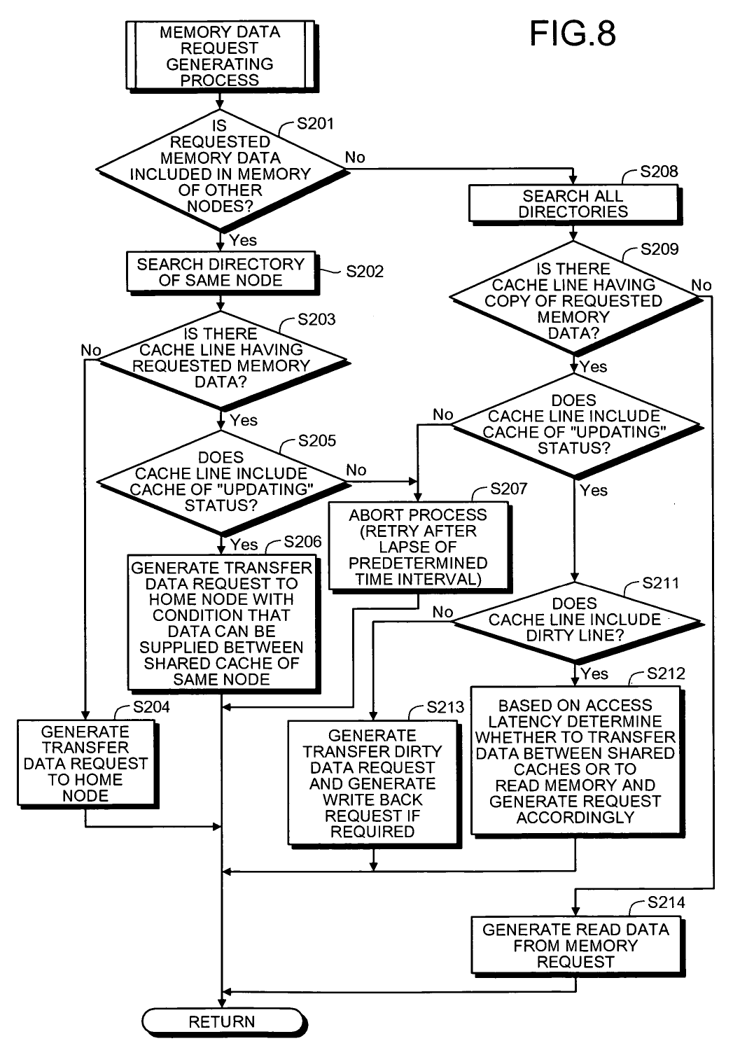

FIG. 8 is a flowchart of the memory data request generating process at step S109. As shown in FIG. 8, in the memory data request generating process, the coherence controller 100 determines whether the data requested by the SMP 10 is included in the memory 13 of other nodes (step S201)

If the requested memory data is included in the memory 13 of other nodes, the coherence controller 100 searches the directories 110 within the same node (step S202), and determines whether the cache line that includes the memory data requested by the SMP 10 is included in the same node (step S203).

If the cache line that includes the memory data requested by the SMP 10 is not included in the same node, the coherence controller 100 generates a transfer data request to the home node (step S204). If the cache line that includes the memory data requested by the SMP 10 is included in the same node, the coherence controller 100 determines whether the cache line includes a cache of “Updating” status (step S205). If the cache line does not include a cache of “Updating” status, because data from other shared caches 12 in the same node can be used, the coherence controller 100 generates a transfer data request to the home node with a condition that enables to supply the requested memory data between the shared caches 12 in the same node (step S206). If the cache line includes a cache of “Updating” status, because the updating process needs to be completed first, the coherence controller 100 carries out an abort process that makes a retry after lapse of a predetermined time interval (step S207).

If the memory data requested by the SMP 10 is not included in the memory 13 of other nodes, the coherence controller 100 searches all the directories 110 (step S208) and determines whether there is a cache line that includes a copy of the memory data requested by the SMP 10 (step S209).

If there is a cache line that includes a copy of the memory data requested by the SMP 10, the coherence controller 100 determines whether the cache line includes a cache of “Updating” status (step S210). If the cache line includes a cache of “Updating” status, because the updating process needs to be completed first, the coherence controller 100 carries out an abort process that makes a retry after lapse of a predetermined time interval (step S207). If the cache line does not include a cache of “Updating” status, the coherence controller 100 determines whether the cache line includes a Dirty line (a cache having the latest data that does not match with data in the memory) (step S211).

If the cache line does not include a Dirty line, the coherence controller 100, based on access latency, determines whether to transfer data between the shared caches 12 or to read memory, and creates a transfer data request or a read memory request based on the result (step S212). If the cache line includes a Dirty line, the coherence controller 100 generates a transfer Dirty data request, and generates a write back request if necessary (step S213).

If there is no cache line that includes a copy of the memory data requested by the SMP 10, the coherence controller 100 generates a request to read the memory data from the memory 13 (step S214).

If the memory data requested by the SMP 10 can be supplied from the shared caches 12 within the same node, the coherence controller 100 generates a transfer data request to the home node with a condition that enables the requested memory data to be supplied from the shared caches 12 within the same node. Thus, the coherence controller 100 of the home node can be notified that data transfer can be carried out between the shared caches 12 of the local node.

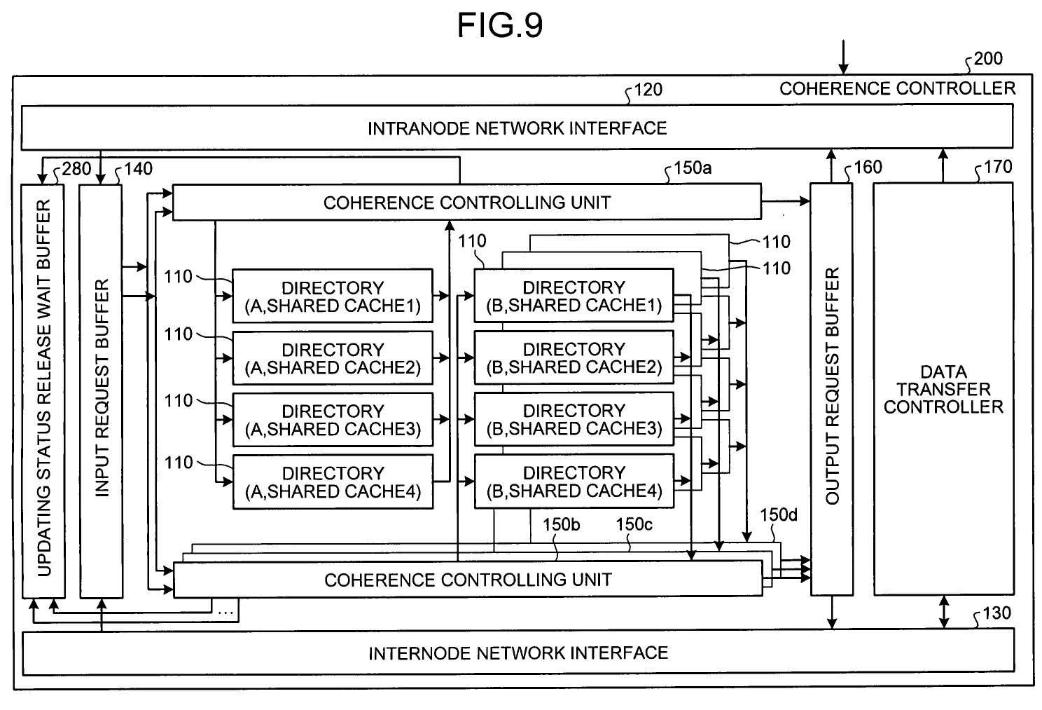

The abort process that makes a retry after lapse of a predetermined time interval is explained at step S207. However, a store data request from the SMP 10 can also be stored by providing an updating status release wait buffer. FIG. 9 is a block diagram of a coherence controller provided with an updating status release wait buffer. As shown in FIG. 9, a coherence controller 200 includes an updating status release wait buffer 280 added to the coherence controller 100 shown in FIG. 2. When the “Updating” status of a cache in a directory has changed to “Not updating” status, if there is a wait status request in the updating status release wait buffer 280 included in the coherence controller 200 that maintains the directory, the wait status request is input into the input request buffer 140.

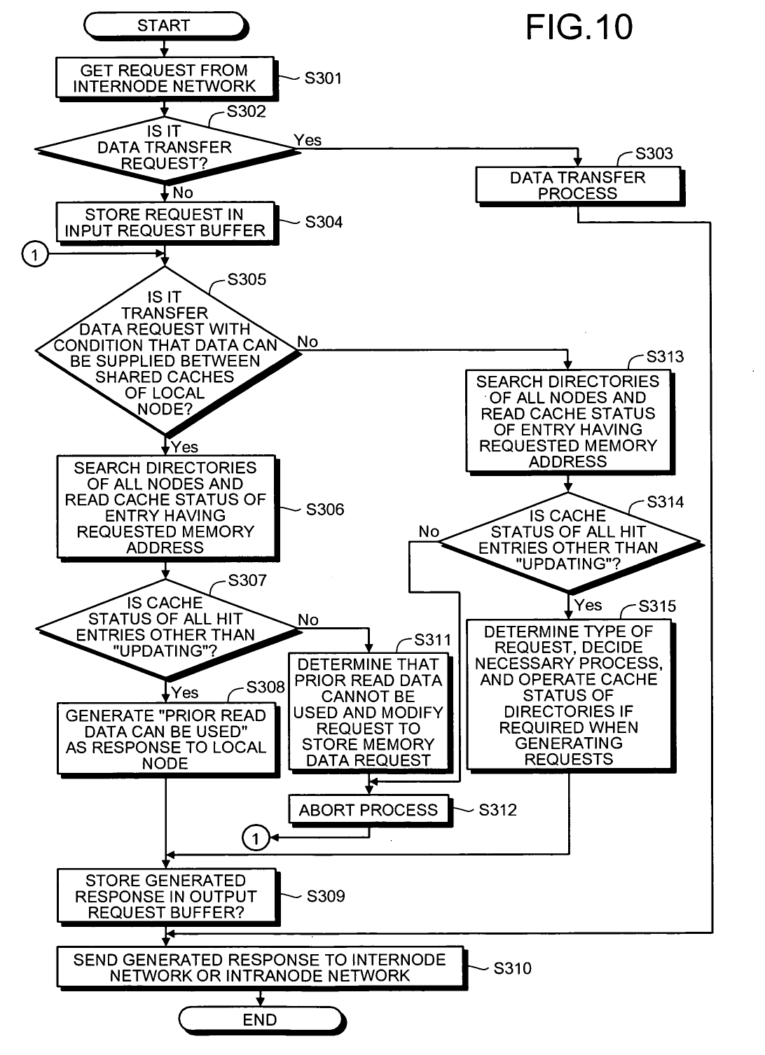

FIG. 10 is a flowchart of the process performed by the coherence controller 100 of the home node focused on the process in response to the transfer data request generated during the memory data request generating process shown in FIG. 8.

As shown in FIG. 10, the coherence controller 100 of the home node, upon receiving a request from the internode network 30 (step S301), determines whether the received request is a transfer data request (step S302).

If the received request is a transfer data request, the coherence controller 100 of the home node carries out a data transfer process (step S303), and transmits the requested memory data to the SMP 10 via the intranode network 20 (step S310).

If the received request is not a transfer data request, the coherence controller 100 of the home node stores the request in the input request buffer 140 (step S304). Next, the coherence controller 100 of the home node takes the request from the input request buffer 140 and determines whether the request is a transfer data request having a condition that enables supplying of the memory data between the shared caches 12 of the local node (step S305). If the request is a transfer data request having the condition that enables supplying of the memory data between the shared caches 12 of the local node, the coherence controller 100 of the home node searches the directories 110 of all the nodes, reads the cache status of the entry having the requested memory address (step S306), and determines whether the cache status of all the hit entries is other than “Updating” (step S307).

If the cache status of all the hit entries is other than “Updating”, the coherence controller 100 of the home node generates “Prior read data can be used” as a response to the local node (step S308), stores the generated response in the output request buffer 160 (step S309), and transmits the generated response to the internode network 30 (step S310).

If there is an entry among the hit entries having “Updating” status, the coherence controller 100 of the home node determines that prior read data cannot be used and modifies the request to a store memory data request (step S311) and carries out an abort process (step S312). In the abort process, the store memory data request is stored in the updating status release wait buffer 280 as shown in FIG. 9, or the store memory data request is input into the input request buffer 140 and a retry made if predetermined conditions are satisfied.

If the request is not a transfer data request having the condition that enables supplying of the memory data between the shared caches 12 of the local node, the coherence controller 100 of the home node searches the directories 110 of all the nodes, reads the cache status of the entry having the requested memory address (step S313), and determines whether the cache status of all the hit entries is other than “Updating” (step S314).

If the status of all the hit entries is other than “Updating”, the coherence controller 100 of the home node determines the type of request, decides the necessary process, generates a request to the SMP 10 etc., operates the status of the directories 110 if required (step S315), stores the generated requests in the output request buffer 160 (step S309), and sends the generated requests to the intranode network 20 or the internode network 30 (step S310). If there is an entry among the hit entries that has “Updating” status, the coherence controller 100 of the home node carries out an abort process (step S312).

Thus, the coherence controller 100 of the home node, upon receiving a transfer data request having the condition that enables supplying of the requested memory data between the shared caches 12 of the local node, searches the directories 110 of all the nodes, and if the cache status of all the entries having the requested memory data is other than “Updating”, sends “Prior read data can be used” as a response to the local node, thereby enabling to transfer data between the shared caches 12 of the local node by means of the prior read data and increase the speed of data transfer in response to the store data request.

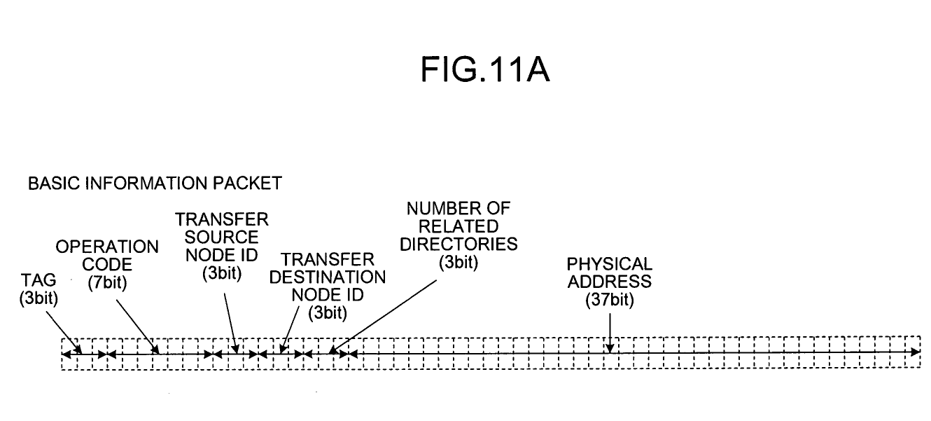

A request packet transferred between the nodes is explained with reference to FIG. 11A through FIG. 13. FIG. 11A and FIG. 11B are drawings of a format of the request packet. As shown in FIG. 11A and FIG. 11B, the request packet includes a basic information packet for transmitting basic information, and a directory specifying information packet for transmitting information for specifying directory entry. The directory specifying information packet is added to the basic information packet depending on the basic information. A request packet of fixed length is explained in the present embodiment. However, a request packet of variable length can also be used.

The basic information packet includes a tag, an operation code, a transfer source node ID, a transfer destination node ID, number of related directories, and a physical address. The tag is a code used to specify the type of the information included in the packet and the location of the information. The operation code is information to specify content of the request. The transfer source node ID is an identifier to identify a transfer source node of the request packet. The transfer destination node ID is an identifier to identify a transfer destination node of the request packet.

The number of related directories is a number of directory informations sent by the directory specifying information packet. The number of directory specifying information packets is dependent on the number of related directories. When the number of related directories is “0”, the directories 110 are searched with the aid of the physical address. The physical address is an address of the request data. Among the aforementioned types of information, existence of some types of information is dependent on the operation code, and existence of some types of information is not dependent on the operation code. For example, a completion notification can be issued without including the physical address.

The directory specifying information packet includes sets consisting of a tag, a node ID that identifies a node, a cache ID that identifies the shared cache 12, and a way ID that identifies a way. The number of sets included in the directory specifying information packet is equal to the number of related directories of the basic information.

For example, when transmitting a request from the local node to the home node, the related directories are not attached except when inquiring whether prior read data can be used. When transmitting a request from the home node to the remote node, because the destination node is already specified during request transmission, the node ID of the directory specifying information can be left blank.

When transmitting a request from the home node to multiple remote nodes, if a node-based specification of the request is not required, the request can be generated (sent) in two ways that are explained next. The home node, either generates and sends a request packet to every destination node, or the home node identifies the destination mode with the aid of the directory specifying information. The home node attaches a special mark to the destination node of the basic information and sends a request having added the directory specifying information. Because the number of related directories cannot be expressed in terms of display bits, the number of related directories needs to be divided into a number of requests having a displayable number of related directories and sent if the number of related directories cannot be included in a single request. In other words, the request needs to be generated in a way that covers all the related directories when the sent requests are grouped. Next, the request packet having the special mark, which is sent from the home node, is divided into multiple packets by means of a destination determining process unit inside the internode network 30 and sent to all the nodes that are specified by the directory specifying information.

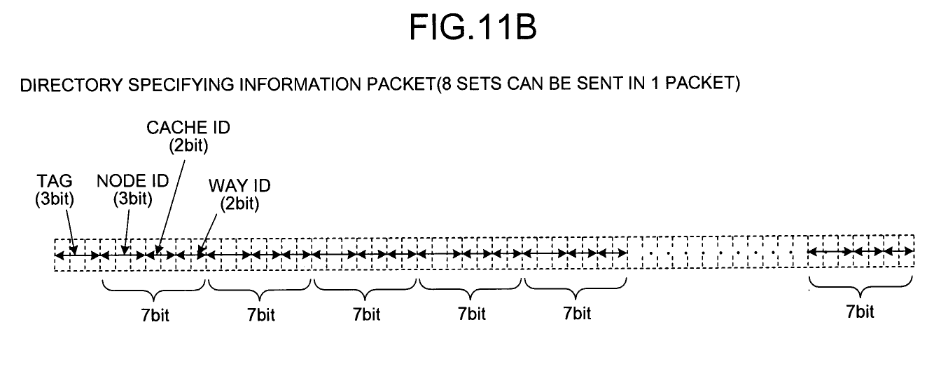

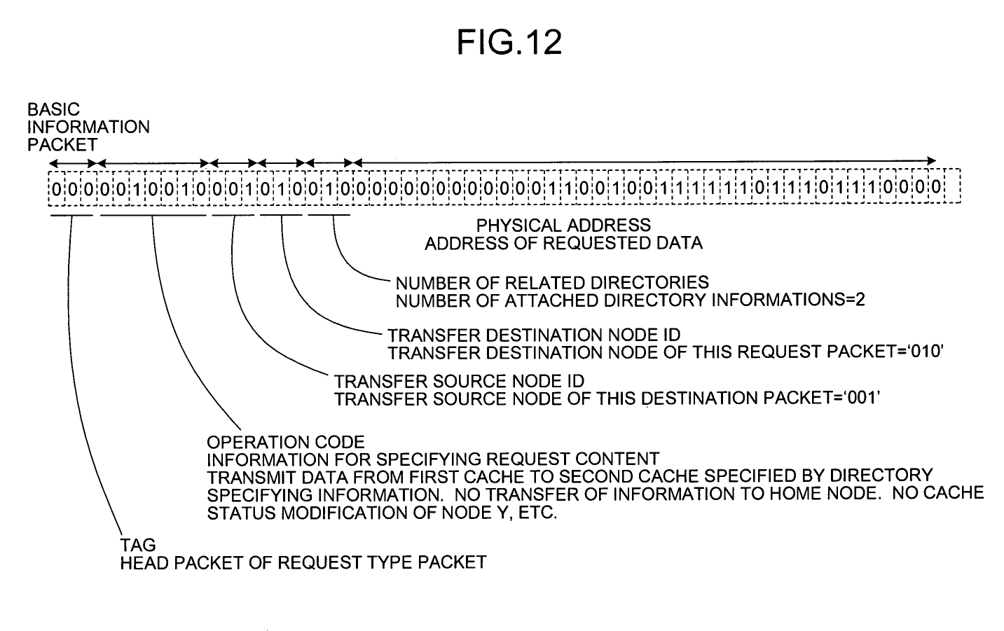

FIG. 12 is a drawing of an example of the basic information packet. FIG. 13 is a drawing of an example of the directory specifying information packet. The basic information packet and the directory specifying information packet shown in FIG. 12 and FIG. 13 are examples of packets when a home node X (having ID ‘001’) sends a request to a remote node Y (having ID ‘010’). The content of the request is “Transfer data from a cache (having ID ‘11’) of the remote node Y to a local node Z (having ID ‘100’) without cache status modification of the remote node Y. Transfer of information from the remote node Y to the home node X notifying completion of the data transfer is not required”.

The coherence controller 100 can specify an entry in the directory 110 by means of unique information even if the entry is included in the directory 110 of any node. Thus, by including the directory specifying information packet in a new request packet whenever necessary, the frequency of directory search in response to a new request can be reduced, thereby increasing the speed of searching process.

In the present embodiment, the coherence controller 100 of each node includes the directories 110 that establish a one to one correspondence with all the shared caches 12 of all the nodes. Thus, occurrence of conflict between entries of the directory 110 can be prevented and coherence control can be carried out with simplicity and increased speed.

In the present embodiment, the intranode network 20 connects the SMP 10. Thus, the SMP 10 can communicate with the other SMP 10 without communicating via the coherence controller 100, thereby increasing the speed of communication between the SMP 10.

In the present embodiment, “Updating” status, which indicates that the entry is being updated, is provided as a cache status of entries in the directory 110, thereby enabling to carry out lock control exclusively by means of the directory 110.

In the present embodiment, by providing the “Updating” status in the directory 110, accountability for status updating can be assigned to any node that satisfies predetermined conditions. Thus, coherence control can be carried out without assigning the accountability for status updating to fixed nodes such as the home node or the local node unlike in conventional methods, thereby increasing the speed of coherence control.

In the present embodiment, the coherence controller 100 issues a store data request to the coherence controller 100 of the home node and simultaneously confirms whether the requested memory data is included in the shared caches 12 within the same node. The shared cache 12, upon receiving an instruction to transfer the memory data from the coherence controller 100, transfers via the intranode network 20 to the shared cache 12 causing a cache mishit, the requested memory data that is prior read based on a request broadcast from the controlling unit 12d of the shared cache 12 causing the cache mishit and stored in the temporary buffer 12c. Thus, if a cache mishit occurs in the shared cache 12 and the requested memory data is included in the other shared cache 12 within the same node, the memory data can be speedily transferred to the shared cache 12 of the store data request source.

In the present embodiment, the coherence controller 100 can specify an entry in the directory 110 by means of unique information even if the entry is included in the directory 110 of any node. Thus, by including the directory specifying information packet in a new request packet whenever necessary, the frequency of directory search in response to a new request can be reduced, thereby increasing the speed of searching process.

Because conventional directory methods are applied to a large-scale parallel computer system, it is practically impossible to provide in each node, directories that establish a one to one correspondence with all the shared caches 12. Moreover, considering the scale of the computer systems used in business, because snoopy coherence protocol is regarded as high performing and cost effective, coherence control is carried out by means of the snoopy coherence protocol. However, by using the coherence controller 100 having the aforementioned structure, demerits of the directory method are reduced, thereby enhancing the performance of coherence control.

According to the present invention, the speed of coherence control is increased, thereby enhancing the performance of a distributed shared memory system.

According to the present invention, the speed of communication between shared caches within a node is increased, thereby enhancing the performance of the distributed shared memory system.

According to the present invention, if a requested memory data is included in other shared caches within the same node, the memory data is speedily transferred to a shared cache of a request source, thereby enhancing the performance of the distributed shared memory system.

According to the present invention, a table that controls updating status of a cache line for lock control does not need to be provided separately, thereby removing the need to provide a memory necessary for the table, and reducing the cost to search the table.

According to the present invention, a notification of receipt of the memory data is not required, thereby increasing the speed of coherence control and enhancing the performance of the distributed shared memory system.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A distributed shared memory system comprising a plurality of nodes, each of the nodes including a plurality of shared multiprocessors, each of the shared multiprocessors including a processor, a shared cache, and a memory, wherein
each of the nodes including a coherence maintaining unit that maintains cache coherence based on a plurality of directories each of which corresponding to each of the shared caches included in the distributed shared memory system.

2. The distributed shared memory system according to claim 1, wherein the coherence maintaining unit further includes a plurality of pipelines that process a plurality of requests respectively.

3. The distributed shared memory system according to claim 1, further comprising an intranode-shared-cache connecting unit that connects the shared caches of each of the nodes, wherein the coherence maintaining unit is connected to the intranode-shared-cache connecting unit.

4. The distributed shared memory system according to claim 3, wherein the intranode-shared-cache connecting unit is a network.

5. The distributed shared memory system according to claim 3, wherein the intranode-shared-cache connecting unit is a bus.

6. The distributed shared memory system according to claim 1, wherein
the nodes include a first node and a second node,
the first node includes a first coherence maintaining unit,
the second node includes a second coherence maintaining unit,
the first coherence maintaining unit sends a request for data stored in one of the memories of the second node to the second coherence maintaining unit, and
the request includes information specifying in which directory and where of the directory an entry corresponding to the data is included.

7. The distributed shared memory system according to claim 1, wherein
the nodes include a first node and a second node,
the first node includes a first coherence maintaining unit, a first shared multiprocessor, and a second shared multiprocessor,
the second node includes a second coherence maintaining unit, and a third shared multiprocessor including a memory that stores data, and
the first coherence maintaining unit includes
a determining unit that determines, when the data is requested from the first shared multiprocessor due to a cache mishit, whether the data is stored in a shared cache of the second shared multiprocessor;
a read instructing unit that instructs, when the data is stored in the shared cache, the shared cache to read out and store the data in a temporary buffer;
a sending unit that sends an inquiry on usability of the data read out and stored in the temporary buffer to the second coherence maintaining unit;
a receiving unit that receives a response to the inquiry from the second coherence maintaining unit; and
a transfer instructing unit that instructs, when the response is affirmative, the shared cache to transfer the data to the first shared multiprocessor.

8. The distributed shared memory system according to claim 7, wherein the sending unit sends the inquiry to the second coherence maintaining unit at substantially same time the transfer instructing unit instructs the shared cache to transfer the data to the first shared multiprocessor.

9. The distributed shared memory system according to claim 1, wherein the coherence maintaining unit carries out a lock control of the shared caches based on a status included in each of the entries of the directories, the status including an updating status indicating data is being updated.

10. The distributed shared memory system according to claim 9, wherein
the nodes include a first node and a second node,
the first node includes a first coherence maintaining unit,
the second node includes a second coherence maintaining unit,
a shared multiprocessor of the first coherence maintaining unit sends a request for data stored in one of the memories of the second node to the second coherence maintaining unit via the first coherence maintaining unit due to a cache mishit, and
the second coherence maintaining unit includes
a transfer instructing unit that instructs, when the request is received, a shared cache storing the data to transfer the data to the first coherence maintaining unit; and
a status updating unit that updates, before an acknowledgement is received from the first coherence maintaining unit in response to the data transferred, the status included in an entry of a directory that corresponds to a shared memory of the shared multiprocessor from the updating status to another status.

11. A multiprocessor device that includes a plurality of processors, a plurality of shared caches, and a memory, and forms a distributed shared memory system with another multiprocessor device connected to the multiprocessor device via a network, the multiprocessor device comprising:
a shared-cache connecting unit that connects the shared caches; and
a coherence maintaining unit that is connected to the shared caches via the shared-cache connecting unit.

12. A method of maintaining cache coherence of a distributed shared memory system including a plurality of nodes, each of the nodes including a plurality of shared multiprocessors, each of the shared multiprocessors including a processor, a shared cache, and a memory, the method comprising:
receiving a request for one of the shared caches included in the distributed shared memory system from one of the shared multiprocessors; and
maintaining, when the request received is a store request, the cache coherence based on a plurality of directories each of which corresponding to each of the shared caches included in the distributed shared memory system.

13. The method according to claim 12, wherein the maintaining includes maintaining the cache coherence using a plurality of pipelines that process a plurality of requests respectively.

14. The method according to claim 12, wherein the shared caches of each of the nodes are connected via an intranode-shared-cache connecting unit.

15. The method according to claim 14, wherein the intranode-shared-cache connecting unit is a network.

16. The method according to claim 14, wherein the intranode-shared-cache connecting unit is a bus.

17. The method according to claim 12, wherein
the nodes include a first node and a second node,
the first node includes a first coherence maintaining unit,
the second node includes a second coherence maintaining unit,
the method further includes
sending including the first coherence maintaining unit sending a request for data stored in one of the memories of the second node to the second coherence maintaining unit, and
the request includes information specifying in which directory and where of the directory an entry corresponding to the data is included.

18. The method according to claim 12, wherein
the nodes include a first node and a second node,
the first node includes a first coherence maintaining unit, a first shared multiprocessor, and a second shared multiprocessor,
the second node includes a second coherence maintaining unit, and a third shared multiprocessor including a memory that stores data, and
the method further includes
determining, when the data is requested from the first shared multiprocessor due to a cache mishit, whether the data is stored in a shared cache of the second shared multiprocessor;
instructing, when the data is stored in the shared cache, the shared cache to read out and store the data in a temporary buffer;
sending an inquiry on usability of the data read out and stored in the temporary buffer to the second coherence maintaining unit;
receiving a response to the inquiry from the second coherence maintaining unit; and
instructing, when the response is affirmative, the shared cache to transfer the data to the first shared multiprocessor.

19. The method according to claim 18, wherein the sending the inquiry to the second coherence maintaining unit and the instructing the shared cache to transfer the data to the first shared multiprocessor are performed at substantially same time.

20. The method according to claim 12, wherein the maintaining includes carrying out a lock control of the shared caches based on a status included in each of the entries of the directories, the status including an updating status indicating data is being updated.
